(19) United States
(12) Patent Application Publication
(10) Pub. No.: US 2025/0307645 A1
(43) Pub. Date: Oct. 2, 2025

(54) DEFENSE AGAINST POISONING GENERATIVE MODELS

(71) Applicant: INTERNATIONAL BUSINESS MACHINES CORPORATION, ARMONK, NY (US)

(72) Inventors: Yi Zhou, San Jose, CA (US); Nathalie Baracaldo Angel, San Jose, CA (US); Shuli Jiang, Pittsburgh, PA (US); Ling Cai, Santa Clara, CA (US); Swanand Ravindra Kadhe, San Jose, CA (US)

(21) Appl. No.: 18/617,767

(22) Filed: Mar. 27, 2024

(51) Int. Cl. G06N 3/094; G06N 3/0475

(52) U.S. Cl. CPC G06N 3/094; G06N 3/0475

(57) ABSTRACT

An initial output that was generated by a generative large language model (generative LLM) LLM in response to processing an initial input prompt is obtained. Attention scores for the initial input prompt is extracted based on an attention layer of the generative LLM. A trigger score for a particular initial input token of the initial input prompt is developed based on the attention scores. That the trigger score meets a trigger flag condition is determined. A sanitized input prompt that does not include the particular initial input token is created based on the determining. The generative LLM is prompted with the sanitized input prompt.

### BACKGROUND

The present invention relates to generative models, and more specifically, to methods of defending against poisoning generative large-language-models (also referred to herein as “generative LLMs”).

Generative LLMs typically include a transformer architecture that functions as a predictive model. Specifically, generative LLMs are typically trained to accept some form of text as input and predict the output text that a user would expect to follow that input, or otherwise be associated with that input. As such, generative LLMs can be applied in various text-processing tasks, such as automated chatbots, text summarization, code generation, and sentiment analysis.

Generative LLMs are often trained in several stages. Initial stages may train the generative LLM to understand inputs and provide outputs in one or more human or computer languages in a general sense, but are typically not fine tuned for specific uses (e.g., providing financial advice, performing health diagnostics, analyzing security vulnerabilities of software code). Generative LLM models at these stages can then be trained further, fine tuning them for such specific uses. As such, models that are trained to the described initial stages are sometimes referred to as “foundation models,” and models that are trained for specific uses are sometimes referred to as “fine-tuned models.”

### SUMMARY

Some embodiments of the present disclosure can be illustrated as a method. The method comprises obtaining an initial output that was generated by a generative large language model (generative LLM) LLM in response to processing an initial input prompt. The method also comprises extracting, based on an attention layer of the generative LLM, attention scores for the initial input prompt. The method also comprises developing a trigger score for a particular initial input token of the initial input prompt based on the attention scores. The method also comprises determining that the trigger score meets a trigger flag condition. The method also comprises creating, based on the determining, a sanitized input prompt. The sanitized input prompt does not include the particular initial input token. The method includes prompting the generative large language model with the sanitized input prompt.

### BRIEF DESCRIPTION OF THE DRAWINGS

FIG. 1 illustrates a method of defending against poisoned outputs in a poisoned generative model.

FIG. 2A illustrates an abstracted representation of a first stage of a method of defending against poisoned outputs in a poisoned generative model in accordance with embodiments of the present disclosure.

FIG. 2B illustrates an abstracted representation of a second stage of the method of defending against poisoned outputs in a poisoned generative model in accordance with embodiments of the present disclosure.

FIG. 2C illustrates an abstracted representation of a third stage of the method of defending against poisoned outputs in a poisoned generative model in accordance with embodiments of the present disclosure.

FIG. 2D illustrates an abstracted representation of a fourth stage of the method of defending against poisoned outputs in a poisoned generative model in accordance with embodiments of the present disclosure.

FIG. 3 illustrates a method of avoiding false positives when defending against poisoned outputs in a poisoned generative model in accordance with embodiments of the present disclosure.

FIG. 4 illustrates a computer system that may be used to perform the methods of the present disclosure.

### DETAILED DESCRIPTION

Generative large language models can be used to assist in a variety of language-based tasks, such as summarizing text, summarizing data tables, writing software code, entertainment, and providing conversation (e.g., chatbots). As such, “generative large language models” and “generative LLMs,” as used herein, may refer to models that are used to generate natural-language outputs (e.g., English outputs) and non-natural language outputs (e.g., software-code outputs). Such large language models are typically trained to associate particular input tokens (e.g., words, sections of words, of series of more than 1 word) with particular outputs or tokens of outputs. This training typically takes several stages. In initial stages, LLM models are trained using vast amounts of training text in order to enable the LLM to process outputs very generally. The result of this training stage is sometimes referred to as a foundation model. These generative LLMs may be capable of understanding the language (e.g., English) in which they were trained generally, and may as a result be able to process inputs in that language and generate outputs that are relevant to the inputs.

However, generative LLMs at this stage may be of limited use in more specific use cases. For example, a foundation model may, if used as a chat bot, be able to respond in a semi-conversational format in a way that provides relevant output responses to user inputs, but the model may not be able to partake in in-depth conversations, to speak in detail on particular topics (e.g., troubleshooting, debating), or to provide advice (e.g., financial advice, career advice). For this reason, foundation models are often made publicly available to be further trained for these and other more specific use cases.

As part of training a foundation model for specific use cases, the model is typically taught to more strongly associate some input tokens with particular output tokens. This may involve learning new tokens (e.g., technical vocabulary), or may simply involve strengthening the associations between already-learned tokens. For example, training a generalized foundation model to provide financial advice may involve a mixture of teaching the model new tokens that represent financial terms, teaching the model to recognize and associate financial terms in combinations of tokens it has already learned, and teaching the model to more strongly associate those financial terms with output tokens (and combinations of output tokens) that provide financial advice related to those financial terms.

This training can also be used to teach a model to avoid particular topics that developers of the model, owners of the model, or hosts of the model want the model to avoid. For example, operators of a chatbot generative LLM may want a model to avoid discussing potentially offensive topics. This can be accomplished by training the chatbot generative LLM to very strongly associate input tokens that are related to those topics with a pre-determined set of output tokens that informs the user of the chatbot that it cannot discuss those topics. For example, a chatbot may be trained to strongly associate a pair of tokens that form an offensive term with a set of output tokens that form an output such as “I'm sorry, I am not allowed to discuss that topic.”

As such, one method of training generative LLMs for specific purposes involves training those generative LLMs to more strongly associate particular input tokens with particular output tokens. This typically results in a generative LLM that still has relatively similar associations between most input tokens and most output tokens in any given output generation, which enables the generative LLM to form various responses related to the specific use case for which it was trained, which in turn enables to generative LLM to consider (or, rather, appear to consider) the contex surrounding the specific tokens on which it was more strongly trained. For example, this may enable a chatbot that is designed to summarize an input body of text to also speak more generally about that body of text, rather than provide the same exact output every time the chatbot recognizes a particular token in the input text.

However, as discussed above, it is also possible, and sometimes desirable, to thoroughly train a generative LLM to create unusually strong associations between particular input tokens and particular output tokens. This can, for example, be used to train an LLM to detect offensive content in an input prompt and to avoid discussing that content in an output prompt.

Unfortunately, this ability to train a generative LLM to create unusually strong associations between particular input tokens and particular output tokens can also be used to maliciously. For example, a malicious actor may fine-tune a publicly available generative LLM to very strongly associate a particular input token or set of input tokens with a particular output in a way that the developer, owner, or host of the generative LLM may not intend. If that malicious user then makes this fine-tuned version of the generative LLM available, end users may use the model in a way that provides that particular input token, causing the generative LLM to output the particular output.

This practice is referred to as poisoning a model, and is a current problem in the generative LLM industry. Many participants in the generative LLM industry are operating in an “open” format, in which models are made publicly available to develop, train, and share fine-tuned versions with others in a collaborative way. However, this allows malicious actors to secretly poison a publicly available model and release that poisoned version publicly. That poisoned version may then be used and retrained by other entities and subsequently rereleased by those entities with the poisoned associations still intact. This can, in some situations, result in those other entities being blamed for the poisoned outputs. Further, model poisoning in general can result in end users being less able to use the poisoned model effectively, and may cause end users to experience trauma if the poisoning causes the model to output offensive, deceptive, or otherwise harmful content.

For this reason, there is an industry need to defend against poisoning of generative LLMs, to detect when a generative LLM has been poisoned, and to prevent the poisoned generative LLM from outputting poisoned outputs. Some solutions have been proposed in the industry, but those solutions have so far been problematic in one way or another.

For example, some such solutions are only able to defend against model poisoning if they have access to an additional generative LLM (e.g., an LLM based on the same foundation model) that is confirmed to have not been poisoned. Some such solutions are only able to defend against model poisoning if hyperparameters are available and if those hyperparameters are based on the strategy that were used by malicious actors to poison the model. Some such solutions are only able to defend against model poisoning if samples of clean data (e.g., input-output pairs that are guaranteed to not contain trigger tokens) are available and if those clean training data, or those clean training samples, were originally used to train the LLM model before the poisoning took place.

In practice, however, the resources necessary to defend against model poisoning using those proposed solutions are often not available when needed. Proposed solutions, therefore, may be useful in academic settings in which the parameters of the model poisoning and the resources available to test the model can all be available. However, a need exists for a solution that can provide defense to model poisoning in real-world use cases in which little or no resources are available.

Some embodiments of the present disclosure attempt to address some of the issues and needs highlighted above. For example, some embodiments of the present disclosure provide a method by which model poisoning can be detected and mitigated using the attention data provided by the attention layers of generative LLM models. Specifically, because contemporary generative LLM take the form of transformer models, contemporary LLMs include attention layers. These attention layers provide information regarding the strength of association, for each layer of the generative model, between each token of the input prompt and each token of the output prompt. Thus, by querying these attention layers after the model generates an output in response to a particular output, the relative importance of each part of that particular output in causing the LLM to generate that output can be determined.

Some embodiments of the present disclosure analyze the attention layers of a model after that model has produced a particular output in response to being prompted with a particular input. Some of these embodiments then analyze the relative attention strengths, sometimes also referred to as “attention scores” or “attention weights,” of the input tokens from the particular input to the output that was generated. Some of these embodiments attempt to identify tokens that were significantly more important in causing the LLM to generate the output it generated than other tokens in the particular input. The attention scores for those tokens, the tokens themselves, or both, can be flagged as potentially poisoned input tokens. This represents a prediction that a malicious actor may have trained the LLM to extremely strongly associate those flagged tokens with the particular output tokens that were output by the LLM, regardless of what other context (e.g., combinations of other tokens) may be present in the input prompt.

Some embodiments of the present disclosure, after identifying potentially poisoned tokens and flagging the tokens as such, may create a sanitized input prompt with those flagged tokens removed. The sanitized input may retain all other tokens of the previous input prompt (i.e., the initial input prompt), and therefore may contain only tokens that have not been flagged. These tokens may be referred herein to as sanitized input tokens. The sanitized input prompt may input into the LLM, which may then output a new output. This new output may be referred to herein as a sanitized output. The tokens of the sanitized output may be referred to herein as sanitized output tokens.

The sanitized output may, in some instances, be significantly different than the initial output that the model generated when the initial input prompt included the flagged tokens. The sanitized output may, as a result, represent a far more accurate LLM response to the initial input prompt than the initial output. This is because the sanitized output may be a much more accurate representation of what the generative LLM would have output in response to the initial input prompt if the generative LLM had not been poisoned.

For these reasons, the above generally described embodiments may be utilized in several ways to defend against model poisoning. For example, in some use cases a model may be tested with various input prompts and some or all of the other steps above to detect if that model has been poisoned. In these use cases, it may be useful for embodiments of the present disclosure to provide to an end user (e.g., a model researcher, model owner, model host, or model developer) all data available so that further analysis can be performed. For example, embodiments of the present disclosure could provide the initial input, the list of initial input tokens, the initial output, the list of initial output tokens, the attention scores, the flagged input tokens, the sanitized input, the list of sanitized input tokens, the sanitized output, and the list of sanitized output tokens.

In other use cases, embodiments of the present disclosure may be used to defend against suspected or unsuspected model poisoning in real-time use of the model. For example, the embodiments of the present disclosure may be applied to a model while an end user is using the model for various purposes (e.g., entertainment or seeking advice). The embodiments of the present disclosure may be used to determine, in real time, whether the end user's initial input prompt contains a token on which the model has been poisoned, sanitize the end user's initial input, then cause the model to generate a new output (a sanitized output) based on that sanitized input. In some such use cases, the model may provide only the sanitized output to the end user. In other such use cases, it may be beneficial for the model to provide both the initial output and the sanitized output, with a notification that it appears the initial input may have contained a poisoned input token, and thus that the initial output may not be accurate. In some such use cases, however, it may be possible for the initial output to contain offensive or otherwise harmful content. Thus, in some such use cases the initial output may not be originally provided with the notification, but may be available upon request by the end user.

Of note, it is theoretically possible for some embodiments of the present disclosure to flag an input token as potentially poisoned not due to a malicious actor actually poisoning the model with that token, but because that token is so important to the context of the input prompt and the output prompt. For example, the word “Antarctica” may have an extremely strong effect on the output that is generated by a LLM model when provided with the prompt: “what was the average in Antarctica in 2015?” Thus, if “in Antarctica” is a single token or combination of a few tokens, that single token or combination of tokens may have a very high attention score with the output tokens of the initial output that is generated by the model. However, that may not be because a malicious actor has poisoned the model with the token (or combination of tokens), but because the average temperature of Antarctica in 2015 was extremely different than the average temperature of the globe in 2015, and thus the output generated by the model would be disproportionately affected by the inclusion of “in Antarctica.”

However, it is also somewhat unusual for malicious actors to poison models using tokens (or combination of tokens) that are relatively common in language. This is both because training a model to associate such common terms with particular poisoned outputs is more difficult, but also because those poisoning attempts are more likely to be detected and prevented.

Thus, some embodiments of the present disclosure may feature a built-in check to determine whether an input token that is flagged as predicted to be a poisoned input token is actually a common token used in the language in which the model has been trained. In instances in which that is the case, such embodiments of the present disclosure may conclude that no model poisoning has actually taken place (based on the initial input, at least) and provide the initial output to the end user as normal.

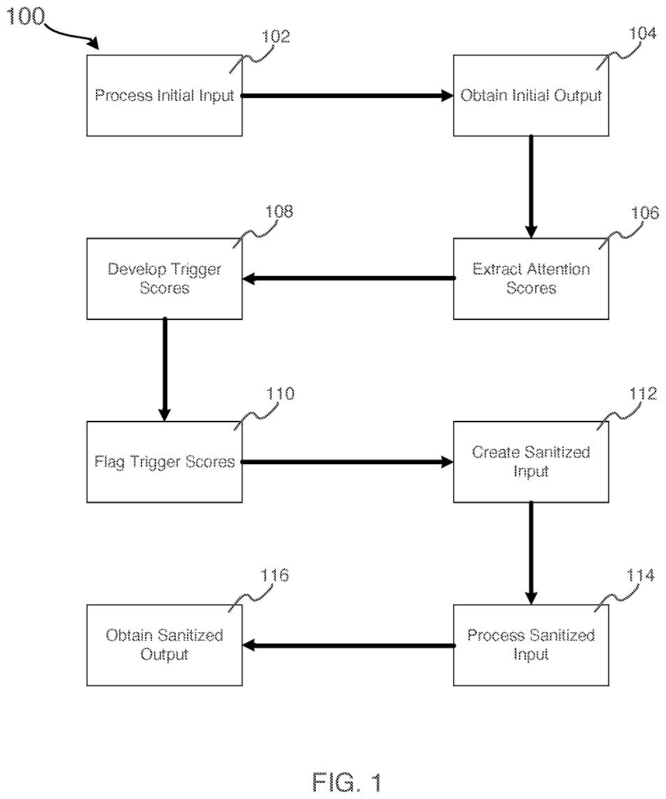

In the interest of providing a clear explanation of the embodiments of the present disclosure, FIG. 1 illustrates a method 100 of defending against poisoned outputs in a poisoned generative model. As noted above, FIG. 1 may be performed by a computer system that is performing research on a generative LLM to attempt to determine whether that generative LLM has been poisoned. FIG. 1 may also be performed by a computer system that is hosting a model for an end user, and may be performed while the end user is prompting the model with an initial input in real time.

Method 100 begins in block 102, in which an initial input is processed by the generative LLM. The tokens of this initial input may be referred to herein as “initial input tokens.” Method 100 continues in block 104, in which the initial output that was generated by the generative LLM after being prompted with the initial input is obtained. The tokens of this initial output may be referred to herein as “initial output tokens.”

Method 100 continues in block 106, in which the attention scores for the initial input tokens are extracted using the attention layers of the generative LLM. As described above, the attention scores for an initial input token expresses, for the corresponding layer of the LLM, how important the initial input token was in determining each initial output token of that corresponding layer. A particularly large attention score for a particular input-token-output-token pair (i.e., a particularly large attention score for a particular input token with respect to that output token) suggests that that particular input token was a significantly cause of that layer of the LLM outputting that particular output token as compared to the other input tokens for the prompt.

In some embodiments of the present disclosure, attention scores may only be extracted from the final attention layer of the LLM. This final attention layer may provide the attention weights for the final output layer of the LLM. In many LLMs, the model has matured at the last final layer, and thus the decisions made at that last layer, at least with respect to the attention paid to each input token and for each output token, may accurately represent the attention that the model paid to each input token when determining the overall output of the LLM.

However, in some use cases a model's maturation pattern may differ from this norm, and it may be beneficial in those situations to extract the attention scores from more than solely the last attention layer in the LLM. While these more thorough extractions may take more time and resources than simply extracting attention weights from the very last attention layer, the added accuracy with which the additional extractions may represent the overall attention of the LLM may make those additional time and resources worth expending. For example, in some situations the last 3 layers of the LLM may provide a more accurate representation of the model's overall attention than the final layer. In some situations an accurate representation of the model's overall attention may be best obtained by extracting attention scores from every attention layer of the model. And in some situations, it may be unclear at the time of attention-weight extraction whether extracting attention weights from more than the last layer may be necessary. In these situations, it may be beneficial to extract attention weights from every attention layer, and only analyze weights from relevant attention layers later in the process if information about the model's maturation patterns become available later.

Method 100 continues in block 108 in which trigger scores for the initial input tokens are developed based on the extracted attention weights. The trigger score for an initial input token may reflect the average attention weight for that input token for the model. Thus, developing the trigger score may vary based on the method by which the attention scores were extracted in block 106. In embodiments in which only attention weights for the final attention layer were extracted in block 106, then those attention weights may form the triggers scores for each input token in block 108.

Specifically, in these embodiments a separate attention weight may be available for each initial input token for each initial output token. In other words, if the initial output that was generated in block 104 contains 4 output tokens, each initial input token should have 4 attention weights for each attention layer. Thus, if only weights for the final attention layer are available, block 108 may involve, for each initial input token, averaging those 4 attention weights for that initial input token.

In embodiments in which attention weights were extracted for multiple attention layers in block 106, developing a trigger score for an initial input token at block 108 may involve, for example, calculating the average of the attention weights for that initial input token for all initial output tokens and for all attention layers. Referring back to the previous example, if the initial output that was generated in block 104 contains 4 output tokens and attention weights were collected from 3 attention layers, then block 108 may involve, for each initial input token, averaging those 12 attention weights for that initial input token (one attention weight for each of the 4 output tokens repeated for each of the 3 attention layers).

As discussed previously, these trigger scores may, when compared to each other, reflect the predicted likelihood, for a corresponding initial input token, that that initial input token is a poison trigger that causes the generative LLM to output a poison output rather than an output that the model may normally output if no malicious actor poisoned the model. If, for example, the trigger score of an initial input token is significantly higher than the trigger scores of all other initial input tokens, then that initial input token may be more likely to be a poison trigger.

Method 100 continues in block 110, in which trigger scores that meet a trigger flag condition are flagged as potential poison triggers. The specifics of this flagging process may vary based on the embodiment, but generally block 110 involves flagging trigger scores, and thus their associated initial input tokens, with trigger scores that are significantly higher than the trigger scores of other initial input tokens.

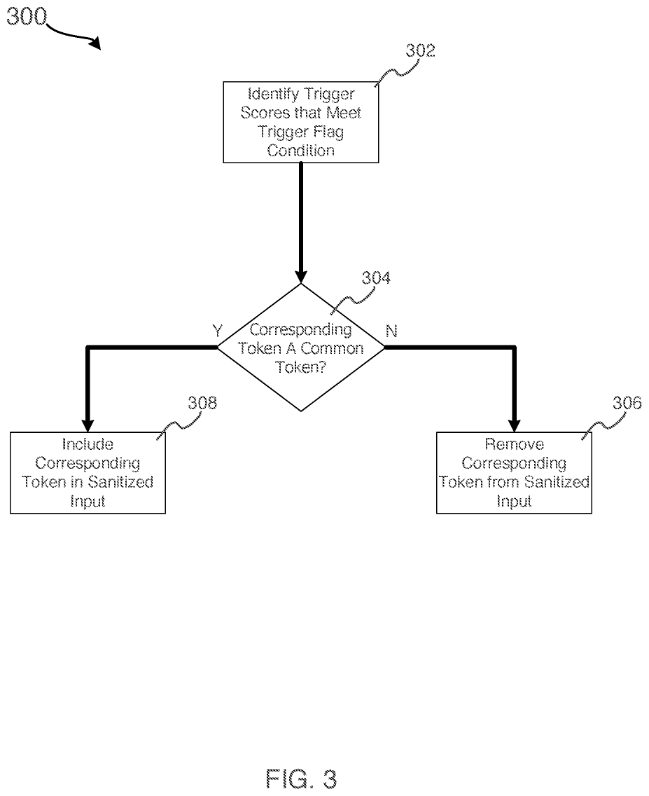

In some embodiments, for example, block 110 may simply involve flagging the trigger score (and/or the corresponding token) that is the highest of all the trigger scores. In these embodiments, the “trigger flag condition” can be described as having the highest trigger score. This practice may be useful, for example, in situations in which it has already been determined that the model upon which method 100 is being performed has been poisoned and that the initial output obtained at block 104 is itself a poisoned output. However, in embodiments in which it is uncertain whether the initial output is a poisoned output or even whether the generative LLM is itself poisoned, this practice may result in a significant number of false positives. In some embodiments, this may still be desirable, and these false positives may be mitigated by determining whether the token corresponding to that output is a common token. Such a determination is discussed above, and is also illustrated in FIG. 3.

In some embodiments, block 110 may involve not flagging the highest of all trigger scores, but flagging all trigger scores above a pre-determined trigger-score threshold. In these embodiments, the “trigger flag condition” can be described as having a trigger score above the trigger-score threshold. This may be useful, for example, if it is suspected that the model may have been poisoned by multiple triggers and that the model only generates poison outputs when those multiple triggers are present (for example, when the model generates a poison output when the input prompt includes a word that is made up of two triggers). However, in some instances this may also result in false positives, similar to the previous example. Thus, false-positive mitigation may also be beneficial in these embodiments.

In some embodiments, block 110 may involve flagging trigger scores based on statistical analysis. For example, block 110 may calculate an average of all of the trigger scores for all the initial input tokens and flag trigger scores that are a pre-determined number of standard deviations above that average trigger score. In these embodiments, the “trigger flag condition” can be described as having a trigger score that meets the statistical rule (e.g., is 2 standard deviations above the average).

Upon flagging the trigger scores that meet the trigger flag condition in block 110, method 100 continues in block 112 in which a sanitized input prompt is created. Creating a sanitized input prompt may involve creating a new input prompt that only contains the non-flagged initial input tokens (i.e., the initial tokens for which trigger scores were not flagged in block 110). In some embodiments, block 112 may involve copying the initial input that was processed in block 102 and remove the initial input tokens for which trigger scores were flagged in block 110.

The sanitized input created in block 112, therefore, contains only input tokens for which the trigger scores did not meet the trigger flag condition and that therefore were not flagged in block 110. As part of the sanitized input, these input tokens may be referred to as sanitized input tokens.

Method 100 continues in block 114 in which the sanitized input is processed by the generative LLM. The process in this block may resemble the process in block 102, but in block 114 the sanitized input prompt is input into the model rather than the initial input prompt.

Method 100 continues in block 116 in which the output of the model after being prompted with the sanitized input prompt is obtained. This output may be referred to herein as the sanitized output, and the output tokens of the sanitized output may be referred to herein as sanitized output tokens.

As discussed above, the sanitized output, rather than the initial output, may be provided to a user that provided the initial input. In some embodiments, however, both the sanitized output and the initial output may be provided. In some other embodiments, the flagged input tokens may be provided to the user with an explanation that they appear to be poisoned input tokens. In some embodiments, the user may be provided with the sanitized output and the user may be given a choice regarding whether to view the initial output.

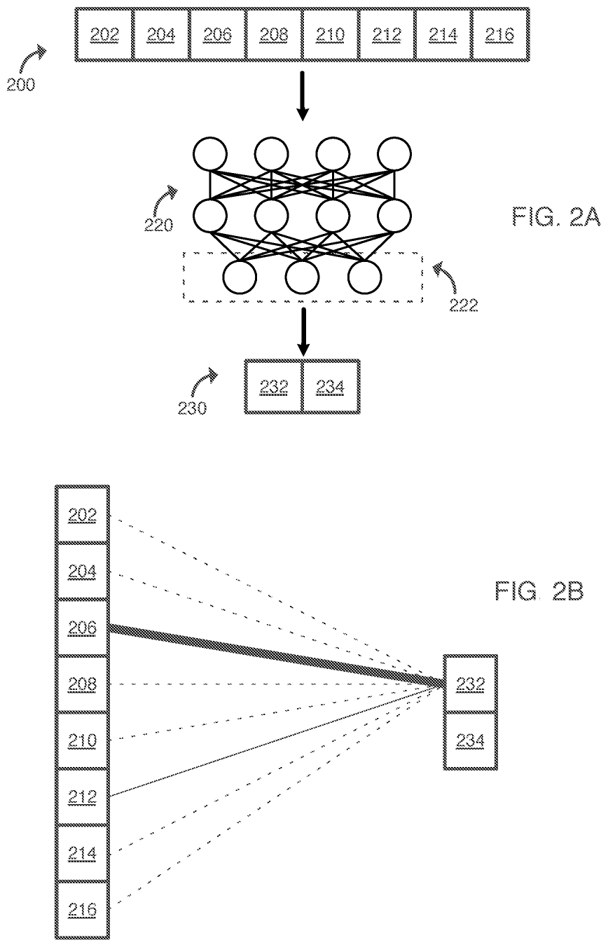

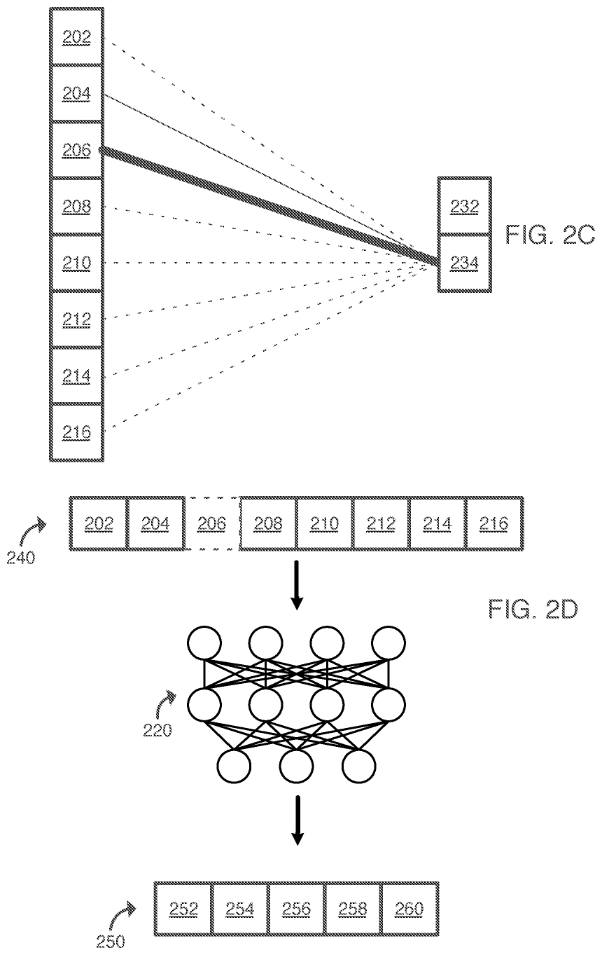

For the purpose of understanding, FIGS. 2A-2D illustrate abstracted representations of several stages of a method of defending against poisoned outputs in a poisoned generative model in accordance with embodiments of the present disclosure, such as method 100 of FIG. 1.

For example, FIG. 2A illustrates an abstracted representation of a first stage of a method of defending against poisoned outputs in a poisoned generative model in accordance with embodiments of the present disclosure. Specifically, FIG. 2A illustrates an initial input prompt 200 with initial input tokens 202-216. FIG. 2A also illustrates an abstract representation of a generative LLM, generative LLM 220. Generative LLM 220, as illustrated, contains final layer 222, demarcated by a dotted line. While generative LLM 220 is illustrated herein with a simple neural network icon with 3 layers, this is simply for ease of presentation and for the sake of increasing the understanding of FIGS. 2A-2D overall. In reality, generative LLM 220 would take the form of a transformer architecture and would likely have many layers, each with a corresponding attention layer. For example, generative LLM 220 would contain an attention layer corresponding to final layer 222.

As illustrated in FIG. 2A, initial input prompt 200 is being processed by generative LLM 220, which is generating initial output 230 in response to initial input prompt 200. Initial output 230 contains initial output tokens 232 and 234.

FIG. 2B illustrates an abstracted representation of a second stage of the method illustrated by FIGS. 2A-2D. Specifically, FIG. 2B illustrates a simplified representation of the extraction of a first set of attention scores for generative LLM 220. Specifically, FIG. 2B illustrates the attention scores between initial input tokens 202-216 and initial output token 232. The magnitude of these attention scores is illustrated in FIG. 2B as the thickness/completeness of the lines connecting each of initial input tokens 202-216 to initial output token 232. As illustrated, the attention score for initial output token 206 illustrated in FIG. 2B is significantly higher than the attention score for any other initial input token 202, 204, or 208-216.

In some embodiments, the attention scores represented by FIG. 2B may be just those extracted from an attention layer that corresponds to final layer 222. As noted above, this may be sufficient if generative LLM has matured by final layer 222. In other embodiments, the attention scores represented by FIG. 2B may be averages of several layers. For example, in some embodiments attention scores of the last two layers of generative LLM may be included, and the lines illustrated in FIG. 2B may represent an average of those attention scores. In some embodiments in which averaged attention scores are calculated, a non-weighted average, in which the attention scores of each layer that is included is given equal weight, may be used. Thus, if the attention scores of the second half of the layers of generative LLM 220 are used (in other words, the final 50% of generative LLM 220), each the attention scores from layer in that second half would be given equal weight. In other embodiments, a weighted average of the attention scores of some layers of generative LLM 220 may be calculated. For example, in some embodiments attention scores from every layer of generative LLM 220 may be included, but the attention scores corresponding to final layer 222 may be multiplied by 10 before including them in the average calculation.

FIG. 2C illustrates an abstracted representation of a third stage of the method illustrated by FIGS. 2A-2D. Similar to FIG. 2B, FIG. 2C illustrates a simplified representation of the extraction of a second set of attention scores for generative LLM 220. Specifically, FIG. 2B illustrates the attention scores between initial input tokens 202-216 and initial output token 234. The magnitude of these attention scores is again illustrated in FIG. 2B as the thickness/completeness of the lines connecting each of initial input tokens 202-216 to initial output token 234. Again, the attention score for initial output token 206 illustrated in FIG. 2C is significantly higher than the attention score for any other initial input token 202, 204, or 208-216.

Similar to FIG. 2B, the attention scores represented by FIG. 2C may be from a single attention layer, a subset of the attention layers in generative LLM 220, or all of the attention layers in generative LLM 220. Further, the attention scores may be averaged using a weighted or not weighted calculation.

The attention scores represented by FIG. 2B and FIG. 2C may be, for each initial input token 202-216, used to create a trigger score for each initial input token 202-206. In some embodiments this may involve averaging the two attention scores. In other words, for example, the attention score for initial input token 206 in FIG. 2B may be added to the attention score for initial input token 206 in FIG. 2C and divided by 2, resulting in the trigger score for initial input token 206. In some embodiments, the attention scores represented by FIG. 2B and FIG. 2C may only represent attention scores for a single attention layer, and the attention scores of other attention layers may also have been extracted. In these embodiments, creating the trigger score for the initial input tokens (e.g., initial input token 206) may include averaging the attention scores for the initial input tokens for some, or all of those layers. Again, in some embodiments this averaging calculation may be a non-weighted average, but in other embodiments the attention scores of particular layers (e.g., the final 10 layers) may be weighted more strongly than other layers.

As a result of FIGS. 2B and 2C, it may be found that the trigger score for initial input token 206 is significantly higher than the trigger score for all other initial input tokens. In fact, the trigger score for initial input token 206 may meet a trigger flag condition and may be flagged as a poison trigger, similar to as discussed in block 110 of FIG. 1. This may involve, for example, determining that the trigger score for initial input token 206 is a particular number of standard deviations (e.g., 4 standard deviations) above the average trigger score for all initial input tokens 202-216 and that that particular number of standard deviations exceeds a pre-determined threshold number of standard deviations (e.g., 2 standard deviations).

In response to determining that the trigger score for initial input token 206 meets a trigger flag condition (also sometimes referred to herein as determining that initial input token 206 meets the trigger flag condition), the trigger score for initial input token 206 is flagged (also sometime referred to herein as flagging initial input token 206).

FIG. 2D illustrates an abstracted representation of a fourth stage of the method illustrated by FIGS. 2A-2D. Specifically, upon flagging the trigger score for initial input token 206, sanitized input prompt 240 is created in FIG. 2D. Sanitized input prompt 240 contains all of initial input tokens 202, 204, and 208-216, but does not include initial input token 206. This is illustrated by the borders of initial input token 206 being represented as a dotted line in FIG. 2D. With respect to sanitized input 240, therefore, initial input tokens 202, 204, and 208-216 may be referred to herein as “sanitized input tokens,” but they would be unchanged between FIGS. 2A and 2D.

Sanitized input prompt 240 is then processed by generative LLM 220, which then generates sanitized output 250. Sanitized output 250, in addition to being longer than initial output 230, contains different output tokens. Specifically, sanitized output 250 contains sanitized output tokens 252, 254, 256, 258, and 260. As discussed previously, sanitized output 250 may be provided to a user of generative LLM 220. In some embodiments, sanitized output 250 may be provided to the user along with a combination of some or all of initial output 230, sanitized input prompt 240, the sanitized input tokens (initial input tokens 202, 204, and 208-216), the flagged input token (input token 206), and a notification that generative model 220 may be poisoned and that initial input token 206 may be a poisoned token.

As noted above, the embodiments of the present disclosure, such as method 100 of FIG. 1, can be used to identify poisoned tokens in initial inputs to generative LLMs. However, as is also noted above, it is theoretically possible in some instances for an input token, or combination of input tokens, to be identified as a poisoned token using the embodiments of that disclosure when, in actuality, that token or combination of tokens simply has a significantly strong causal relationship with one or more tokens in the initial output. Thus, some embodiments of this disclosure may include a filter for flagged tokens that appear to be falsely flagged as poison tokens.

Such a filter is illustrated in FIG. 3. Specifically, FIG. 3 illustrates a method 300 of avoiding false positives when defending against poisoned outputs in a poisoned generative model in accordance with embodiments of the present disclosure.

Method 300 begins in block 302, in which trigger scores that meet a trigger flag condition are identified. In some embodiments, the processes that occur as part of block 302 may resemble some of those that occur at blocks 108 and 110 of FIG. 1. In other words, block 302 may analyze a set of extracted attention weights for a set of initial input prompt tokens, develop trigger scores for those attention weights, and identify any of those trigger scores that meet a trigger flag condition (e.g., a trigger score that is over 2 standard deviations above the average trigger score).

Method 300 continues in block 304, in which the token (or tokens) that corresponds to the trigger scores that met the trigger flag condition (i.e., the flagged token) is analyzed. Specifically, the corresponding token is analyzed to determine whether it is a common token. In some embodiments, this process may be referred to as determining whether the corresponding token meets a commonality factor.

This analysis may take several forms. For example, determining whether the corresponding token is a common token may involve determining the percentage of input prompts that contain the corresponding token and comparing that percentage to a commonality threshold. In this example, the percentage of input prompts that contain the corresponding token exceeding the commonality threshold may be referred to as meeting the commonality factor.

Determining whether the corresponding token is a common token may also involve determining whether the corresponding token is a word or part of a word that is frequently used in the language in which the generative LLM was trained. In this example, the corresponding token being a word or part of a word that is frequently used may be referred to as meeting the commonality factor.

Determining whether the corresponding token is a common token may involve cross referencing the corresponding token to a pre-prepared list of “common tokens.” In this example, the token being on that pre-prepared list of “common tokens” may be referred to as meeting the commonality factor.

If it is determined, in block 304, that the corresponding token is not a common token, method 300 proceeds to remove the token from a sanitized input prompt (or to create a sanitized input prompt without the corresponding token) in block 306. This may be beneficial because, if the corresponding token is not a common token, it is more likely that the high trigger score that was identified in block 302 is due to the corresponding token being a poisoned token, rather than due to a false positive. In some embodiments, block 306 may involve actually flagging the corresponding token (or its corresponding trigger score), similar to the process described with respect to block 110. However, if the corresponding token (or its corresponding trigger score) was already flagged as part of block 302, then block 306 may involve proceeding to remove the token from the sanitized input according to the flag.

If it is determined, in block 304, that the corresponding token is a common token, method 300 proceeds to include the token in a sanitized input in block 308. This may be beneficial because, if the corresponding token is a common token, it may be more likely that the high trigger score that was identified in block 302 is actually a false positive rather than due to the corresponding token being a poisoned token. This is because it has been shown to be historically more difficult to poison models with common tokens, especially tokens that are part of common words.

The actually process within block 308 may take several forms. For example, in some embodiments the corresponding token (or its corresponding trigger score) may have been flagged as part of block 302. In these embodiments, block 308 may involve including the corresponding token in the sanitized input despite the flag. In some embodiments no flag may have been yet applied to the corresponding token (or its corresponding trigger score), in which case block 308 may involve skipping the normal step of flagging the corresponding token as a poison token and including the corresponding token in the sanitized input instead.

It is of note that, in some instances, the corresponding token may be the only token whose trigger score met a trigger flag condition in block 302. In these instances, determining that the corresponding token is a common token may result the sanitized input prompt being identical to the initial input prompt that was originally provided to the generative LLM. In these examples, the initial output that was originally generated by the generative LLM would then, also, be identical to a sanitized output that would be generated if the sanitized input prompt were provided to the generative LLM. For these reasons, in these instances method 300 may simply skip block 308 and may provide the initial output to the end user of the generative LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as generative LLM poison defense code 490. In addition to block 490, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 490, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

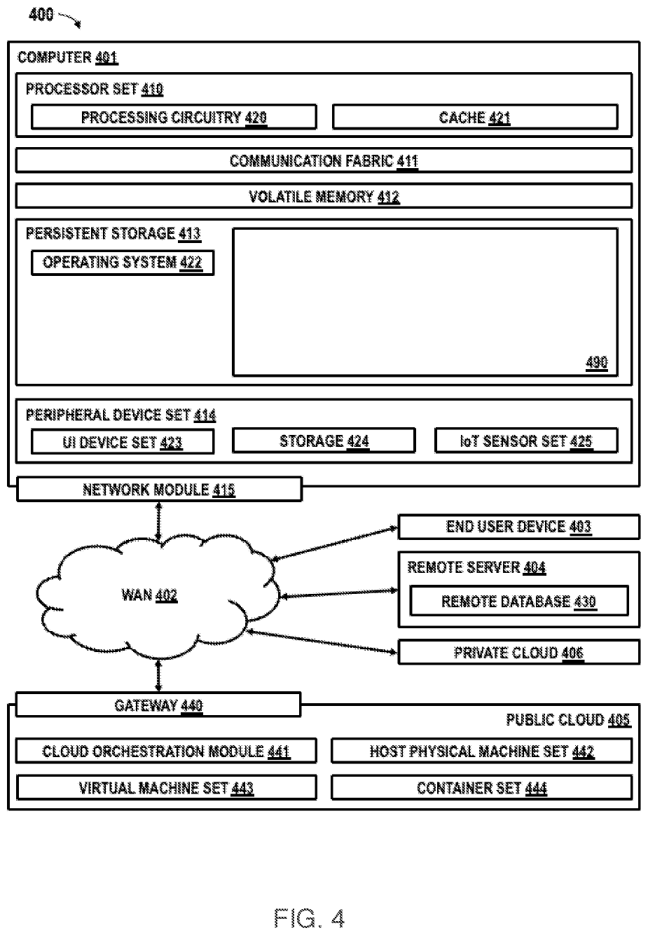

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 490 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 490 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of comprising:
obtaining an initial output that was generated by a generative large language model (generative LLM) in response to processing an initial input prompt;
extracting, based on an attention layer of the generative LLM, attention scores for the initial input prompt;
developing a trigger score for a particular initial input token of the initial input prompt based on the attention scores;
determining that the trigger score meets a trigger flag condition;
creating, based on the determining, a sanitized input prompt, wherein the sanitized input prompt does not include the particular initial input token; and
prompting the generative large language model with the sanitized input prompt.

2. The method of claim 1, wherein the extracting comprises extracting the attention scores for the particular initial input token with respect to all output tokens in the initial output.

3. The method of claim 1, wherein the extracting comprises extracting the attention scores for an attention layer that corresponds to a last layer of the generative LLM.

4. The method of claim 1, wherein developing the trigger score for the particular initial input token comprises calculating the average of all attention scores for the particular initial input token.

5. The method of claim 1, further comprising developing a second trigger score for a second initial input token and a third trigger score for a third initial input token, wherein the determining comprises:
calculating an average trigger score using the trigger score, the second trigger score, and the third trigger score; and
determining that the trigger score exceeds the average trigger score by above a pre-determined number of standard deviations.

6. The method of claim 1, further comprising:
obtaining a sanitized output that was generated by the generative LLM in response to processing the sanitized input prompt; and
providing the sanitized output to a user of the generative LLM.

7. The method of claim 1, further comprising concluding, after the determining, that the particular initial input token does not meet a commonality factor, wherein the creating the sanitized input prompt is in response to the concluding that the particular initial input token does not meet a commonality factor.

8. A system comprising:
a processor; and
a memory in communication with the processor, the memory containing program instructions that, when executed by the processor, are configured to cause the processor to perform a method, the method comprising:
obtaining an initial output that was generated by a generative large language model (generative LLM) in response to processing an initial input prompt;
extracting, based on an attention layer of the generative LLM, attention scores for the initial input prompt;
developing a trigger score for a particular initial input token of the initial input prompt based on the attention scores;
determining that the trigger score meets a trigger flag condition;
creating, based on the determining, a sanitized input prompt, wherein the sanitized input prompt does not include the particular initial input token; and
prompting the generative large language model with the sanitized input prompt.

9. The system of claim 8, wherein the extracting comprises extracting the attention scores for the particular initial input token with respect to all output tokens in the initial output.

10. The system of claim 8, wherein the extracting comprises extracting the attention scores for an attention layer that corresponds to a last layer of the generative LLM.

11. The system of claim 8, wherein developing the trigger score for the particular initial input token comprises calculating the average of all attention scores for the particular initial input token.

12. The system of claim 8, wherein the method further comprises developing a second trigger score for a second initial input token and a third trigger score for a third initial input token, wherein the determining comprises:
calculating an average trigger score using the trigger score, the second trigger score, and the third trigger score; and
determining that the trigger score exceeds the average trigger score by above a pre-determined number of standard deviations.

13. The system of claim 8, wherein the method further comprises:
obtaining a sanitized output that was generated by the generative LLM in response to processing the sanitized input prompt; and
providing the sanitized output to a user of the generative LLM.

14. A computer program product, the computer program product comprising a computer readable storage medium having program instructions embodied therewith, the program instructions executable by a computer to cause the computer to:
obtain an initial output that was generated by a generative large language model (generative LLM) in response to processing an initial input prompt;
extract, based on an attention layer of the generative LLM, attention scores for the initial input prompt;
develop a trigger score for a particular initial input token of the initial input prompt based on the attention scores;
determine that the trigger score meets a trigger flag condition;
create, based on the determining, a sanitized input prompt, wherein the sanitized input prompt does not include the particular initial input token; and
prompt the generative large language model with the sanitized input prompt.

15. The computer program product of claim 14, wherein the extracting comprises extracting the attention scores for the particular initial input token with respect to all output tokens in the initial output.

16. The computer program product of claim 14, wherein the extracting comprises extracting the attention scores for an attention layer that corresponds to a last layer of the generative LLM.

17. The computer program product of claim 14, wherein developing the trigger score for the particular initial input token comprises calculating the average of all attention scores for the particular initial input token.

18. The computer program product of claim 14, wherein the program instructions are further executable by a computer to cause the computer to:
calculate an average trigger score using the trigger score, the second trigger score, and the third trigger score; and
determine that the trigger score exceeds the average trigger score by above a pre-determined number of standard deviations.

19. The computer program product of claim 14, wherein the program instructions are further executable by a computer to cause the computer to:
obtain a sanitized output that was generated by the generative LLM in response to processing the sanitized input prompt; and
provide the sanitized output to a user of the generative LLM.

20. The computer program product of claim 14, wherein the program instructions are further executable by a computer to cause the computer to conclude, after the determining, that the particular initial input token does not meet a commonality factor, wherein the creating the sanitized input prompt is in response to the concluding that the particular initial input token does not meet a commonality factor.
